(19) United States
(12) Patent Application Publication
(10) Pub. No.: US 2026/0091792 A1
(43) Pub. Date: Apr. 2, 2026

(54) SYSTEMS AND METHODS FOR ENHANCING END-TO-END PLANNING FOR AUTONOMOUS DRIVING AND EVALUATION IN CLOSED-LOOP ENVIRONMENT

(71) Applicant: Robert Bosch GmbH, Stuttgart (DE)

(72) Inventors: Feng TAO, CUPERTINO, CA (US); Xin YE, SAN JOSE, CA (US); Burhaneddin YAMAN, SAN JOSE, CA (US); Chenbin PAN, SYRACUSE, NY (US); Abhirup MALLIK, SAN JOSE, CA (US); Liu Ren, SARATOGA, CA (US)

(21) Appl. No.: 18/899,781

(22) Filed: Sep. 27, 2024

(51) Int. Cl. B60W 50/06; B60W 50/00; G06V 10/774; G06V 10/80; G06V 20/58; G06V 20/70

(52) U.S. Cl. CPC B60W 50/06; B60W 50/0097; G06V 10/774; G06V 10/806; G06V 20/58; G06V 20/70; B60W 2420/403

(57) ABSTRACT

Methods and systems for training an end-to-end autonomous driving system using a vision-language planning (VLP) machine learning model in a closed-loop environment. Images associated with an environment about a vehicle are generated, and a BEV model is executed to generate a BEV view based on the images. A planning model predicts navigation trajectories based on the BEV. The VLP model enhances the system by extracting vision-based planning features, generating text prompts, and employing a language encoder to create text-based expectation features. A contrastive learning model identifies similarities between vision and text features, boosting the performance of the BEV and planning models. The system undergoes closed-loop evaluation in a simulated environment, capturing metrics to refine the autonomous driving system.

### TECHNICAL FIELD

The present disclosure relates to systems and methods for vision-language planning (VLP) foundation models for autonomous driving, and evaluation thereof in a closed-loop environment.

### BACKGROUND

An autonomous vehicle, often referred to as a self-driving or driverless vehicle, is a type of vehicle capable of navigating and operating on roads and in various environments without direct human control. Autonomous vehicles use a combination of advanced technologies and sensors to perceive their surroundings, make decisions, and execute driving tasks.

Autonomous vehicles are typically equipped with a variety of sensors, including lidar, radar, cameras, ultrasonic sensors, and sometimes additional technologies like GPS and IMUs (Inertial Measurement Units). These sensors provide real-time data about the vehicle's surroundings, including the positions of other vehicles, pedestrians, road signs, and road conditions. The vehicle's onboard computers use data from sensors to create a detailed map of the environment and to perceive objects and obstacles. This information is essential for navigation and collision avoidance.

Machine learning (ML) and artificial intelligence (AI) play a crucial role in autonomous vehicles. Deep learning algorithms are used for tasks like object detection, lane keeping, and decision-making, and can rely on image processing to perform these tasks. These algorithms enable the vehicle to understand and respond to complex and dynamic traffic situations.

### SUMMARY

According to one aspect of the present invention, a method of training an end-to-end autonomous driving system utilizing a vision-language planning (VLP) machine learning model in a closed-loop environment comprises receiving images generated from a plurality of image sensors mounted to a vehicle; executing a BEV machine-learning model based on the images to generate a bird eye view (BEV) of the environment; executing a planning machine-learning model on the BEV to generate predicted trajectories to navigate the autonomous vehicle in the environment; executing a VLP machine-learning model to improve the end-to-end autonomous driving system, including extracting vision-based planning features associated with detected agents within the environment, wherein the vision-based planning features include spatiotemporal information associated with detected agents in the images; generating text prompts based on the extracted spatiotemporal information associated with detected agents in the images; passing the text prompts through a language encoder to generate text-based expectation features associated with the detected agents; executing a contrastive learning model to derive similarities between the vision-based planning features and the text-based expectation features; boosting the BEV model and the planning model based on the similarities; performing closed-loop evaluation of the end-to-end autonomous driving system with the boosted BEV model and the boosted planning model by interacting with a simulated environment in real-time and responding dynamically to actions taken by the vehicle based on the predicted trajectories; capturing evaluation metrics during the closed-loop evaluation; and modifying the end-to-end autonomous driving system based on the captured evaluation metrics.

According to another aspect, an end-to-end autonomous driving system utilizing a vision-language planning (VLP) machine learning model in a closed-loop environment comprises a processor and memory including instructions that, when executed by the processor, cause the processor to receive image of an environment about a vehicle; execute a BEV machine-learning model based on the images to generate a bird eye view (BEV) of the environment; execute a planning machine-learning model on the BEV to generate predicted trajectories to navigate an autonomous vehicle in the environment; execute a VLP machine-learning model to improve the end-to-end autonomous driving system by extracting vision-based planning features associated with detected agents within the environment, wherein the vision-based planning features include spatiotemporal information associated with detected agents in the images; generating text prompts based on the extracted spatiotemporal information associated with detected agents in the images; passing the text prompts through a language encoder to generate text-based expectation features associated with the detected agents; executing a contrastive learning model to derive similarities between the vision-based planning features and the text-based expectation features; boost the BEV model and the planning model based on the similarities; and perform closed-loop evaluation of the end-to-end autonomous driving system with the boosted BEV model and the boosted planning model by interacting with a simulated environment in real-time and responding dynamically to actions taken by the vehicle based on the predicted trajectories.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a schematic diagram of a control system configured to control a vehicle, which may be a partially autonomous vehicle, a fully autonomous vehicle, a partially autonomous robot, or a fully autonomous robot, according to an embodiment.

FIG. 4 shows a schematic overview of an end-to-end autonomous driving system, according to an embodiment.

FIG. 5 shows a schematic overview of a contrastive learning model, according to an embodiment.

FIG. 6 shows a schematic of a method of training an autonomous driving system utilizing a vision-language planning (VLP) machine learning model, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In the context of autonomous vehicles, the term “agent” can refer to objects or entities in the environment that surrounds or interacts with the autonomous vehicle. This includes pedestrians, other vehicles, cyclists, road signs, traffic lights, buildings, lane lines, and the like. An “agent” can include objects or features that are being detected by the autonomous vehicle's sensors for use in decision making in controlling the autonomous vehicle.

The term “model” or “module”, in the context of computing devices, is intended to refer to a machine-learning model (e.g., neural network) that is a trainable a computer program that uses an algorithm to learn patterns in data and make predictions or decisions about new data. The various “models” described herein can be executed via one or more processors executing instructions stored in memory, which can collectively be part of a Graphics Processing Unit (GPU), Central Processing Unit (CPU), Application-Specific Integrated Circuits (ASICs), or the like, depending on the specific needs of the model.

This disclosure incorporates by reference, in its entirety, U.S. patent application Ser. No. 18/388,601 titled “VISION-LANGUAGE-PLANNING (VLP) MODELS WITH AGENT-WISE LEARNING FOR AUTONOMOUS DRIVING,” filed Nov. 10, 2023. This disclosure also incorporates by reference, in its entirety, U.S. patent application Ser. No. 18/388,606 titled “SYSTEMS AND METHODS FOR VISION-LANGUAGE PLANNING (VLP) FOUNDATION MODELS FOR AUTONOMOUS DRIVING,” filed Nov. 10, 2023.

Rapid advancements in autonomous driving technology have ushered in a new era of transportation, promising safer and more efficient journeys. Autonomous driving systems generally include three high-level tasks: (1) perception, (2) prediction, and (3) planning. Each of these can be executed on its own respective machine learning model. Perception involves the vehicle's ability to understand and interpret its environment. This task includes various sub-components like computer vision, sensor fusion, and localization. Key elements of perception include object detection (e.g., identification and tracking agents external to the autonomous vehicle), localization (e.g., determining the vehicle's precise position and orientation in the world, often using GPS and other sensors), and sensor fusion (e.g., combining data from different sensors, such as cameras, lidar, radar, and ultrasonic sensors to build a comprehensive view of the surroundings). Prediction involves anticipating how other road users and agents in the environment will behave in the near future. This task often involves using machine learning models to estimate the trajectories and intentions of the agents, including pedestrians, other vehicles, and potential obstacles. Accurate prediction is crucial for making safe driving decisions. Planning involves determining the optimal path and actions for the autonomous vehicle to navigate its environment. This typically includes tasks like route planning, trajectory planning, and decision-making. The planning system considers information from perception and prediction to make decisions such as when to change lanes, when to stop at an intersection, how to react to unexpected events, and the like.

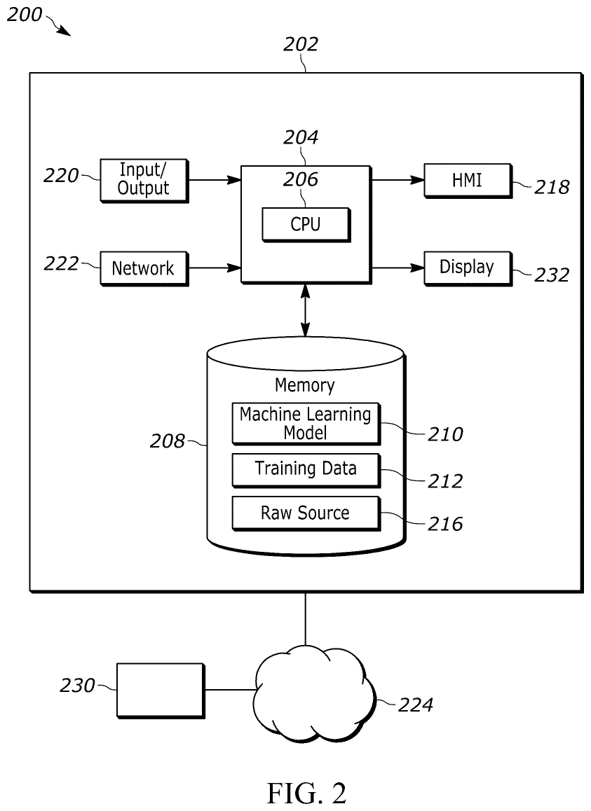

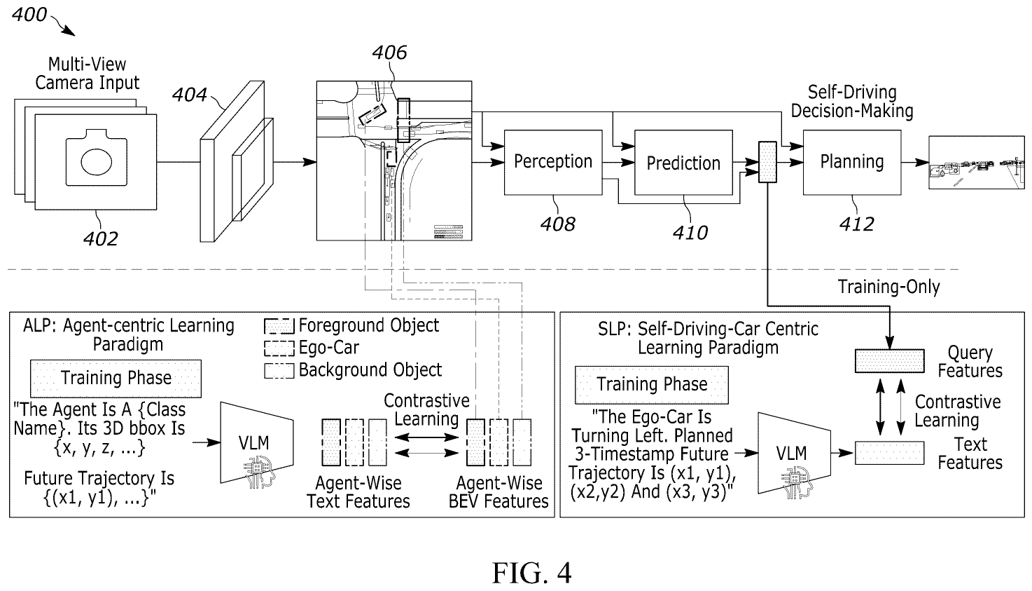

A conventional approach for autonomous driving is to use standalone models in which each task (perception, prediction, and planning) is trained and optimized separately. However, such disjoint training and optimization can lead to severe error accumulation. To address this problem, end-to-end autonomous driving systems have been proposed and gained interest in recent years. End-to-end autonomous driving systems unifies all these tasks and performs joint optimization with a goal to facilitate and improve planning. In particular, end-to-end approaches leverage bird-eye-view (BEV) representations for all tasks in perception, prediction and planning models. BEV is generated from multi-view camera input and contains spatiotemporal information about the scene. A computer vision system (e.g., camera, processor, memory, and machine learning models shown in FIG. 2) can derive the spatiotemporal information about the scene. Joint training and optimization strategy across all tasks in end-to-end autonomous driving have led to state-of-the-art result for autonomous driving. FIG. 4 (described more below) shows an overview of an end-to-end autonomous driving system, according to an embodiment of this disclosure. Central to the success of autonomous vehicles is the integration of diverse modalities that synergistically enhance perception, decision-making, and planning capabilities. In the Unified Autonomous Driving (UniAD) model, which is one of the recent end-to-end autonomous-driving works, the autonomous driving is structured by redefining the interplay between essential components and tasks. In UniAD, the emphasis shifts toward an optimized pursuit of the ultimate goal: effective planning for self-driving vehicles. This entails revisiting the core components of perception and prediction and reconfiguring their roles to synchronize with the overarching planning objective.

While significant progress has been made in computer vision for autonomous driving, a crucial dimension has remained unexplored: the fusion of language comprehension with vision-based planning systems. Foundation models, which are large pre-trained machine learning models trained on open world data, often involve language as one of the main modalities of the data. In foundation models, there is usually connection between language and other modalities. After pre-training, the foundation models can be adapted to a given task via fine-tuning. Foundation models have shown importance of incorporating language in achieving state-of-the-art performance and generalization across wide variety of tasks. Despite the immense success of foundation models across different domains, its extension to autonomous driving domain remains uncharted.

Moreover, despite advancements in vision-based autonomous driving systems, these methods often struggle with reasoning, generalization, and handling long-tail scenarios, which limits their deployment in real-world environments. The emerging progress on multimodal large language models (MLLM) have shown that common sense and reasoning capability of these models can help address the challenges in embodied AI domain. While most of these methods have primarily targeted the robotics domain, there has been limited work on utilizing embodied language models (LMs) for autonomous driving tasks. Notably, DiLu and GPT-Driver introduce GPT-based driver agents for closed-loop simulation tasks. Other systems use an open-loop driving commentator that combined vision and low-level driving actions with language to interpret and reason about driving behaviors. However, it still remains unclear how these approaches can be efficiently distilled and leveraged in enhancing the performance of modular end-to-end autonomous driving tasks.

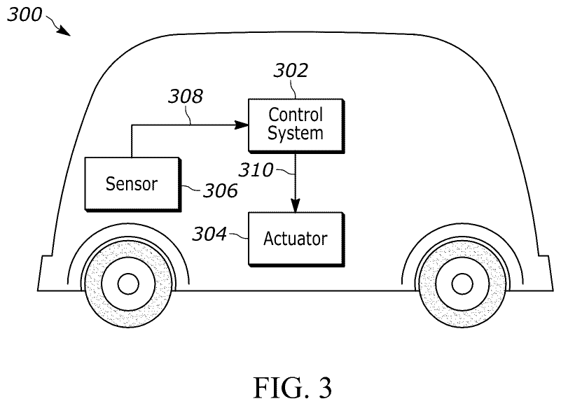

To address these challenges, the present disclosure proposes a novel Vision Language Planning (VLP) framework that efficiently distills the power of vision language models into the autonomous driving through a contrastive learning objective. The VLP framework, illustrated in FIG. 3 and described further below, introduces two components: the Agent-centric Learning Paradigm (ALP) and the Self-driving-car-centric Learning Paradigm (SLP). The ALP enhances the local semantic representation and reasoning capabilities of the BEV feature map, which serves as the source memory in the driving system, by aligning it with human-like reasoning processes. The SLP refines the planning process by aligning planning queries with the goals and status of the self-driving car, using the common-sense reasoning embedded in the language model to guide decision-making. Together, these components improve the system's ability to understand complex driving environments and make safer, more informed decisions.

Additionally, performance evaluation is an essential step in model development for autonomous driving. Evaluation of performance in a standardized manner with common publicly-available dataset and comparison across publicly reported results from the community is referred to as “benchmarking. ” Like most areas of AI, proper benchmarking is important in establishing confidence in the trained model's ability and extending the frontier of innovation. For autonomous driving systems, currently there are several limitations in available benchmarking methods. As most of the benchmarks use open-loop evaluations, they do not evaluate the diverse abilities that are required for autonomous driving in public roads such as responding to unseen actions by other agents. Therefore, according to various embodiments, the present disclosure provides a closed-loop evaluation framework and scenarios provided by Bench2Drive tool—a benchmark designed to evaluate end-to-end autonomous driving systems in a closed-loop environment. This disclosure provides details of the novel benchmarking process and results both in open and closed loop.

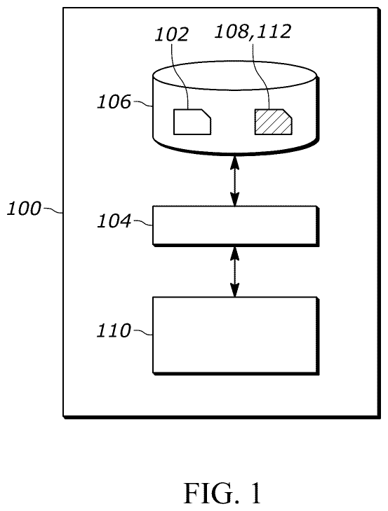

Machine learning and neural networks are an integral part of the inventions disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

FIG. 2 depicts a system 200 to implement the machine-learning models described herein, for example the VLP Foundation model. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data, and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein, including the VLP Foundation model.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In an example, the training dataset 212 may include input images that include an object (e.g., a street sign). The input images may include various scenarios in which the objects are identified. The training dataset 212 may also include the text description of the scene (e.g., “the pedestrian is crossing the street”) that corresponds to the images detected by the vehicle sensors.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data. In the context of the VLP model described herein, a loss between the predicted trajectory of the autonomous vehicle and the ground truth trajectory of the vehicle can be determined, and the VLP model can be trained to reduce this loss, e.g. to convergence.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of agents in video images, annotate the occurrences, and/or command the vehicle to take a specific action (planning) based on the locational data of the agent (perception) and the predicted future movement/location of the agent (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera. And, as will be described further below with respect to the VLP Foundation model, the raw source data 216 can be natural language text information associated with the scene (e.g., “a car is entering the intersection from the left”).

FIG. 3 depicts a schematic diagram of control system 302 configured to control vehicle 300, which may be a partially autonomous vehicle or fully autonomous vehicle, partially autonomous robot or fully autonomous robot. The vehicle 300 and/or its control system 302 can incorporate one or more components of the system 200, such as computing system 202 in order to command an actuator 304 to perform a certain action based upon processing readings from one or more sensors 306. For example, control system 302 can be configured to utilize the VLP foundation model disclosed herein in order to control movement of the vehicle via an output of the VLP model's foundation model that commends actions to be taken by actuator 304.

The one or more sensors 306 may include one or more image sensors (e.g., camera, video sensors, radar sensors, ultrasonic sensors, LiDAR sensors), and/or position sensors (e.g. GPS). The sensors 306 can be configured to generate raw source data 216. One or more of the one or more specific sensors may be integrated into vehicle 300. In the context of agent recognition and processing as described herein, the sensor 306 is a camera mounted to or integrated into the vehicle 300. Alternatively or in addition to one or more specific sensors identified above, sensor 306 may include a software module configured to, upon execution, determine a state of actuator 304.

In embodiments where vehicle 300 is a fully or partially autonomous vehicle, actuator 304 may be embodied in a brake, an accelerator, a propulsion system, an engine, a drivetrain, or a steering system (e.g., steering wheel) of vehicle 300. Actuator control commands may be determined such that actuator 304 is controlled such that vehicle 300 avoids collisions with detected agents, for example. Detected agents may also be classified according to what classifier deems them most likely to be, such as pedestrians or trees. The actuator control commands may be determined depending on the classification.

In other embodiments where vehicle 300 is a fully or partially autonomous robot, vehicle 300 may be a mobile robot that is configured to carry out one or more functions, such as flying, swimming, diving and stepping, via actuator 304. The mobile robot may be an at least partially autonomous lawn mower or an at least partially autonomous cleaning robot. In such embodiments, the actuator control command may be determined such that a propulsion unit, steering unit and/or brake unit of the mobile robot may be controlled such that the mobile robot may avoid collisions with identified objects.

FIG. 4 illustrates a high-level overview of an end-to-end autonomous driving system 400, according to an embodiment. The system 400 shown herein can be referred to as the VLP model or framework disclosed herein. The end-to-end system 400 may be incorporated into the vehicle 300, such as its computing system 202, in order to operate the vehicle to avoid objects or otherwise control the vehicle 300 based on the sensed environment about the vehicle 300.

In general, and as will be described in more detail below, the system integrates VLP in both BEV and the planning model, and evaluates the performance of the system via an adaptation of the simulation framework (e.g., CARLA) to extract language-based descriptions of the ground-truth data and use this information during training. VLP enhances ADS from self-driving BEV reasoning and self-driving decision-making aspects through two innovative modules: ALP and SLP. Leveraging LLM and contrastive learning, ALP conducts agent-wise learning for refining local details on the BEV, while SLP engages sample-wise learning for advancing global context understanding ability of the ADS. VLP can be active during training, ensuring no additional parameters or computations are introduced during inference. To evaluate the pipeline, an open-source benchmarking framework such as Bench2Drive is modified on both its action space (for zero-shot evaluation purposes) and the PID controller for a more realistic application.

At 402, images or image data is received by the system. The images can be generated from one or more image sensors (e.g., cameras) mounted to a vehicle as the vehicle is driving through an environment. For example, the cameras can be mounted so as to take images of the environment in front, to the rear, and to the sides of the vehicle. However, in embodiments, the images and associated data are generated from an open-source tool that simulates real-world driving environments. This open-source tool can be the CARLA (i.e., Car Learning to Act) simulator. The CARLA simulator is an open-source tool that helps researchers develop, train, and test autonomous driving systems. It is built on Unreal Engine and uses the ASAM OpenDRIVE standard to create a realistic simulation of the real world. CARLA is scalable; multiple clients can control different actors in the same or different nodes. It also has a flexible API; users can control many aspects of the simulation, including traffic, pedestrians, and weather. CARLA also has a realistic environment; CARLA's simulation emulates real-world cities, towns, and highways, including vehicles and other objects. CARLA can produce synthetic training data for autonomous driving and other robotics applications. Users can test and evaluate their trained autonomous driving agents within the simulation without risking hardware or other road users.

The generated images can be passed through one or more machine learning layers (e.g., BEV encoder 404) to create a BEV that represents the environment surrounding the vehicle. The BEV encoder 404 can be a computational model or network designed to process and transform data (such as images from multiple cameras) into a bird's-eye view representation of the environment. The BEV encoder's primary function is to transform the perspective-view images into a top-down, bird's-eye view. This involves performing complex geometric transformations, where the encoder estimates the 3D geometry of the scene, maps the camera images to a flat plane (like the road), and combines them into a coherent overhead view. The BEV provides a clear and unobstructed representation of the surroundings, helping to simplify spatial reasoning and navigation.

Once the BEV image is generated, the BEV encoder extracts relevant spatiotemporal features from the scene. These features might include information about various agents in the field of view. For example, these features can include the position and movement of other vehicles, pedestrians, and cyclists; lane markings, road boundaries, and traffic signs; obstacles or hazards that the vehicle needs to navigate around; and the like. The encoder can use convolutional neural networks (CNNs) or other deep learning architectures to extract these features from the BEV image. Moreover, in embodiments, the BEV encoder 404 not only processes camera data but also fuses data from LiDAR, radar, and other image sensors to enhance the perception of the environment. The combination of these multiple data streams helps to create a more robust and accurate BEV representation, particularly for detecting objects or understanding depth and distance. The output of the BEV encoder can be a vectorized or grid-based representation of the scene, which captures key spatial relationships and agent positions in the environment.

As shown in FIG. 4, the output of the BEV encoder (i.e., a BEV 406) can be used as input to all three of the perception, prediction and planning models. For example, the perception model 408 utilizes computer vision based on input received from the image sensors, e.g., the BEV, in order to perform object detection and the like. The prediction model 410 can include machine learning models configured to estimate the trajectories and intentions of the detected agents in the BEV based on those objects past movement, direction, and contextual information. The planning model 412 can include route planning, trajectory planning, and decision-making for the ego vehicle to take to navigate relative to the other objects in the BEV, and turn those decisions into actions taken by the vehicle in real life.

CARLA also has ground truth data associated with the detected agents in the environment. This can include the spatiotemporal information described above with respect to each detected agent in the images. This ground truth information can be extracted for various purposes, as explained elsewhere herein.

As explained above, the VLP framework shown in FIG. 4 includes ALP and SLP components which enhance autonomous driving with self-driving BEV-reasoning and self-driving decision-making aspects. These ALP and SLP components focus on refining local details in the BEV source memory and guiding the planning process of the self-driving car, respectively.

In embodiments, ALP first aligns the ground-truth area of each agent, namely the ego car, foreground objects, and background objects, with the produced BEV map, and crops the regions of interest. Three-dimensional (3D) bounding boxes can be used to crop the ego car and the foreground object areas, and panoptic scene mask can be used to segment the lane areas. As shown in FIG. 4, a bounding box is shown over the ego vehicle, another bounding box is shown over another foreground object (e.g., another vehicle), and another bounding box is shown over a background object (e.g., a lane marking on the road). Subsequently the system performs a pooling operation on the obtained local BEV region to generate a single feature representation for the corresponding agent. After pooling, the local agent features in each sample along the batch are concatenated to formulate an Agent-wise BEV feature tensor.

To ensure that local BEV features express the desired information, the system conducts a BEV-expectation alignment process by leveraging a language model (LM) and contrastive learning. The system defines the perceptual information expected from the corresponding agent, such as the agent labels, bounding boxes, and future trajectories. These driving-related ground-truth information, which can be embedded in the local BEV feature is formulated into a text-based prompt. In other words, the LM can generate text-based prompts based on the ground-truth information associated with the agents. For example, a generated prompt can include text such as “The agent is a {class name}. Its 3D bounding box is located at {x, y, z} coordinates. Its future trajectory is {x1, y1, z1 for time t1}. ” The text prompt can be composed using a template and ground truth information, such as ground truth trajectory or high-level commands existing in the training data. This can be used as the text input 702. For example, “the self-driving car is turning left, and its future trajectory is (x1,y1), . . . (x6,y6)” can be generated based on the ground truth information related to the scene that already exists in the training data; the format of the natural language sentence can be based on a template. Several text entries can be provided for a corresponding number of video or images. With more self-driving related and detailed information included in the sentence, the language path can provide more high-level semantic and comprehensive clues for the planning module. And several irrelevant text strings can also be provided for training purposes. As explained above, the BEV data can be generated by, and extracted from, the open-source simulator (e.g., CARLA), and thus these text prompts can be generated based on extracting text-based descriptions of ground truth data from the open-source simulator.

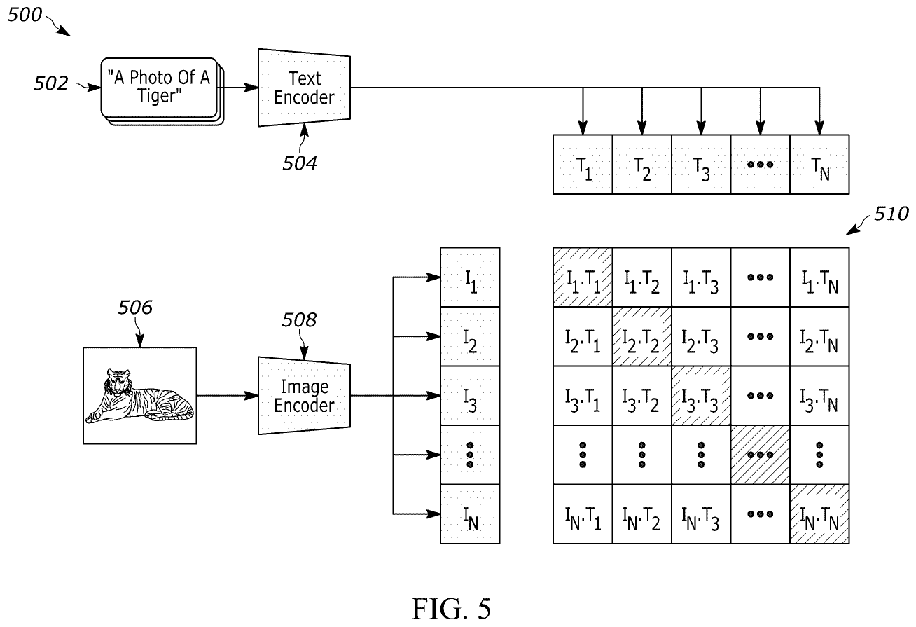

As shown in FIG. 4, the text prompts are then passed to a vision language model (VLM) to generate the corresponding agent expectation feature. The VLM can perform contrastive learning techniques, such as those introduced in a Contrastive Language-Image Pretraining (CLIP) model. Other contrastive learning models can be employed; CLIP is but one example, and is illustrated in FIG. 5. CLIP was developed by OpenAI. It is designed to understand and connect images and natural language descriptions in a way that allows it to perform a wide range of vision and language tasks. CLIP employs a dual-encoder architecture, comprising a vision encoder and a text encoder, and a shared embedding space. The vision encoder processes images, while the text encoder processes natural language descriptions. The vision encoder, based on a vision model like a convolutional neural network (CNN), converts images into a fixed-length vector representation. The text encoder processes textual descriptions by converting them into a fixed-length vector representation. CLIP is a vision-language foundation model trained on open world data using contrastive learning. Contrastive learning is a type of machine learning where the model learns to distinguish between positive and negative pairs of data. In the context of CLIP, the “positive pair” consists of an image and a text description that are semantically related, while the “negative pair” consists of an image and a randomly selected text description that is not related. During training, CLIP is designed to encourage bringing together features from related text and images pairs into a common embedding space, while pushing unrelated pairs apart.

CLIP's shared embedding space allows for zero-shot learning. When presented with an image and a text prompt, CLIP can rank how well the image matches the prompt without specific training data for that particular task. CLIP can perform various vision-language tasks, including image classification, text-based image retrieval (e.g., retrieving images based on textual queries), image captioning, zero-shot object recognition, and others.

The contrastive learning concept used in CLIP (teachings of which are included in the VLP foundation model) is illustrated in FIG. 5, generally shown as a contrastive learning model at 500. As shown, a plurality of natural language text descriptions 502 are fed into a text encoder 504, and a plurality of images 506 are fed into an image encoder 508. The model 500 then performs feature mapping, where the vectors output by the encoders are mapped to a joint embedding space. For example, an image vector output by the image encoder (e.g., of a size 1×256) is matched to a corresponding text vector output by the text encoder (e.g., of a size 1×256). The model then performs a dot product between a batch of image and text features to get the similarity between these vectors, shown generally at 510.

Referring to the example embodied in FIG. 5, a plurality of images 506 (one of which being an image of a tiger in this example) are fed into image encoder 508, and a plurality of text phrases 502 (one of which being something like “a photo of a tiger” in this example) is fed into text encoder 504. Several irrelevant or dissimilar text phrases and images are also fed into the encoders. For example, images of objects that are not tigers are fed into the image encoder 508, and phrases that have nothing to do with tigers are also fed into the text encoder 504. The image encoder produces an image vector having features I₁, I₂, . . . I_{N} while the text encoder produces a text vector having features T₁, T₂, . . . T_{N}. The diagonal of the resulting matrix 510 from this dot product shows paired image and text according to their likely similarity, while the off-diagonal represent unpaired image and text features (e.g., an image of a cat and a text description like “a picture of a dog”).

As such, the contrastive learning model brings the image and text embeddings closer together when they correspond to each other, and pushes them apart when they do not. In other words, referring to FIG. 5, during training, the contrastive learning model aims to increase the similarity of diagonal elements (i.e. positive pairs), while decreasing the similarity between off-diagonal elements. As another example, during training, if the model is provided with an image of a cat and a text description like “a picture of a cat”), the model aims to minimize the distance (similarity) between the image and text embeddings in the shared space; conversely, if the model is provided with an image of a cat and a text description like “a picture of a dog,” the model aims to maximize the distance (dissimilarity) between their embeddings. This contrastive training objective encourages the model to learn to understand the semantic relationships between images and text. It is a way to teach the model to associate matching image-text pairs closely and distinguish non-matching pairs effectively. The result is a shared embedding space where similar pairs cluster together, and dissimilar pairs are far apart.

Returning to FIG. 4, in general, the text prompts can be passed through a language encoder to generate text-based expectation features associated with the detected agents. Also, vision-based planning features associated with detected agents within the environment can be extracted from the BEV that are used by the planning model 412. Then, applying contrastive learning and VLM techniques (e.g., CLIP) to the system 400, CLIP can perform contrastive learning between (1) the text-based expectation features and (2) the vision-based planning features. This derives similarities between the vision-based planning features and the text-based expectation features.

Said another way, in the ALP, the system 400 is operated to extract the ground-truth information from the BEV data to formulate a prompt associated with each agent and the ego vehicle. The descriptions are then passed to the VLM to generate the corresponding agent expectation features. The system can apply a Multilayer Perceptron (MLP) layer or other type of neural network layer to adapt the expectation features to the BEV feature space. Then, the agent expectation features are concatenated along the batch to generate an Agent-wise text feature tensor. The system then performs a contrastive learning loss between the Agent-wise BEV and text-based features for alignment.

In the SLP, the system 400 follows a similar process but focuses exclusively on the ego vehicle. In other words, the text prompts can be generated based on information about the ego vehicle. For example, “The ego-car is turning left. Planned 3-timestamp future trajectory is (x1,y1), (x2,y2), and (x3,y3). ” Thus, the SLP is specifically designed for performing contrastive learning between the text features associated with the planning of the ego vehicle and the image data from the BEV associated with the ego vehicle.

The predicted trajectories of the ego vehicle are generated by the planner model 412, and the VLP with the methods described herein can boost or improve the capability of the planner model 412 (via SLP) and also the BEV model (via ALP) based on the contrastive learning disclosed herein. The determined similarities between the vision-based planning features and the text-based expectation features can improve the output of the planner model 412.

Experiments were conducted on closed-loop environments to determine the effects of the boosted planner model and boosted BEV model. To do this, the Bench2Drive framework was adopted to perform benchmarking. Current benchmarks typically focus on specific tasks or scenarios, neglecting a comprehensive assessment of an autonomous system's overall performance. They often lack diversity in driving environments, road conditions, and traffic scenarios, leading to an incomplete evaluation. This is why Bench2Drive framework is designed to evaluate autonomous driving systems across multiple abilities. This framework includes a wide range of tasks and scenarios to assess perception, planning, and control capabilities in a holistic manner. Bench2Drive also introduces novel metrics that consider safety, efficiency, and comfort, providing a more complete picture of a system's abilities. To perform closed-loop evaluation, Bench2Drive uses the CARLA simulator, as explained above. To address the domain gap between models trained on real dataset and the simulation evaluation environment, Bench2Drive also provides a large CARLA dataset for training. The present disclosure uses this dataset to train the models described herein and evaluates them both in open and closed loop.

Bench2Drive is designed to address several key limitations in the current evaluation frameworks for autonomous driving systems, particularly those focusing on end-to-end autonomous driving (E2E-AD) approaches. Traditional methods often rely on open-loop log-replay evaluations, where models are tested on pre-recorded trajectories, and metrics like L2 error (deviation from recorded paths) or collision rate are used. However, these metrics fail to capture the full complexity of real-world driving, particularly in scenarios that require dynamic decision-making and interactive behaviors. Open-loop evaluations do not account for distribution shifts or causal confusions, where the actions of the vehicle can influence the environment, as would happen in actual driving. Additionally, most benchmarks provide unbalanced datasets, with a significant portion of scenarios being simple (such as straight driving), which do not adequately challenge autonomous systems to handle complex and interactive traffic situations.

Bench2Drive solves these issues by introducing a closed-loop evaluation framework that places the vehicle's decisions in a feedback loop with the environment, allowing for a more realistic and comprehensive assessment of driving performance. In a closed-loop setting, the autonomous vehicle's actions directly affect the environment, which then influences the next set of challenges the vehicle must address. This effectively replicates the real-world conditions where the vehicle's interactions with other road users, traffic signals, and obstacles are unpredictable and require adaptive responses. Bench2Drive implements this closed-loop approach across a diverse set of scenarios, towns, and weather conditions, ensuring that the evaluation covers a wide range of driving skills and environments.

At the core of Bench2Drive is a large-scale, fully annotated dataset that consists of 2 million frames sourced from 10,000 short clips. These clips are collected from 44 interactive driving scenarios, such as cut-ins, overtaking, and detours, all captured under diverse weather conditions (sunny, foggy, rainy, etc.) across 12 towns with varied landscapes (urban, village, university settings). The evaluation protocol requires E2E-AD systems to complete 220 short routes, each about 150 meters in length, that contain a single interactive scenario. This granular approach to scenario design allows for the isolated testing of specific driving abilities, making it easier to identify the strengths and weaknesses of different systems. By focusing on shorter routes, Bench2Drive reduces the variance in performance that can occur in longer route evaluations and offers more reliable, detailed insights into specific driving capabilities.

To ensure fair and algorithm-level comparisons, Bench2Drive provides a standardized, large-scale training dataset, collected using the state-of-the-art expert model Think2Drive. This dataset is annotated with detailed information, including 3D bounding boxes, depth, and semantic segmentation. The annotations span a variety of sensor configurations, including LiDAR, cameras, radar, and HD maps, allowing systems to be trained and tested on diverse sensor inputs. This eliminates the problem of individual teams using their own training datasets, which has previously made direct algorithm comparisons difficult due to differences in data quality and diversity. Bench2Drive's training data ensures that all autonomous driving models are tested under similar conditions, providing a level playing field for evaluating different approaches.

Bench2Drive also contributes to benchmarking methodologies by implementing several state-of-the-art E2E-AD models, including UniAD, VAD, TCP, and ThinkTwice, and evaluating them using both open-loop and closed-loop metrics. The results confirm that traditional open-loop metrics, like L2 error, can be insufficient for comparing the driving capabilities of models, particularly in complex scenarios. By contrast, closed-loop evaluation metrics, such as driving score and success rate, offer a more meaningful assessment of how well a model can navigate interactive and complex traffic situations. Bench2Drive's granular evaluation framework, combined with its extensive training data and closed-loop testing environment, provides the research community with a comprehensive and fair platform for advancing the development of E2E-AD systems.

Evaluation of the models using Bench2Drive is as follows, according to an embodiment. As VLP is a training-only method, the ground truth information from the simulator CARLA needs to be extracted. However, the Bench2Drive framework also provides a pre-extracted dataset with various driving scenarios and actions; this dataset can thus be used to train the system 400. For baseline comparison, the same modifications of VAD are followed that Bench2Drive also recommends. The driving commands are expanded from three to six, including lane change left, lane change right, lane follow as commands. For evaluation, Bench2Drive provides new metrics related to multi-ability evaluation in closed loop. The two main metrics captured are: success rate and driving score. Success rate is proportion of routes that the ego vehicle can complete without any traffic infractions. Driving score is a composite metric, which considers both route completion and penalties for infractions. The traffic infraction penalties are used in multiplicative manner. For open loop evaluation, metrics like displacement error and collision rate percentage are captured. Also, non-planning task related metrics are available like object detection, mapping tracking and prediction.

Bench2Drive offers an ideal framework for evaluating the system 400 in a closed-loop setting, where the actions of the vehicle impact the surrounding environment, providing a more realistic assessment. Bench2Drive includes many interactive driving scenarios (e.g., cut-ins, overtaking, merging), each designed to test specific driving skills. These scenarios, alongside diverse weather conditions and environments, enable comprehensive testing of the system's performance in various real-world conditions. Moreover, the system's ability to generate trajectories based on visual and textual input can be directly tested in a closed-loop environment, where the vehicle's actions influence the agents in the scene (such as pedestrians or other vehicles). This allows for dynamic, real-time evaluation, where Bench2Drive measures how well the vehicle responds to evolving situations. Since Bench2Drive's evaluation includes many short routes, each testing a specific driving scenario, the system performance can be evaluated in isolation for its core planning capabilities. For example, system's ability to plan around pedestrians or cyclists can be tested in scenarios involving pedestrian crossings or complex vehicle interactions. Additionally, Bench2Drive's performance metrics (including success rate and driving score) are used to evaluate how effectively the system 400 navigates routes while avoiding collisions, obeying traffic rules, and successfully completing tasks. The system's predicted trajectory can also be compared to the ground truth trajectory to measure performance and identify areas for improvement, aligning with the loss-based refinement process (e.g., minimizing the error between predicted and actual trajectories).

In a closed-loop evaluation, the results were collected on 110 routes (each around 150 meters in length and containing a single specific scenario) in Bench2Drive benchmark to showcase the closed-loop performance in comparison to the baseline VAD tiny model. Evaluations show the VLP significantly outperforms the VAD in terms of both driving score (by 8%) and route completion (by 13%).

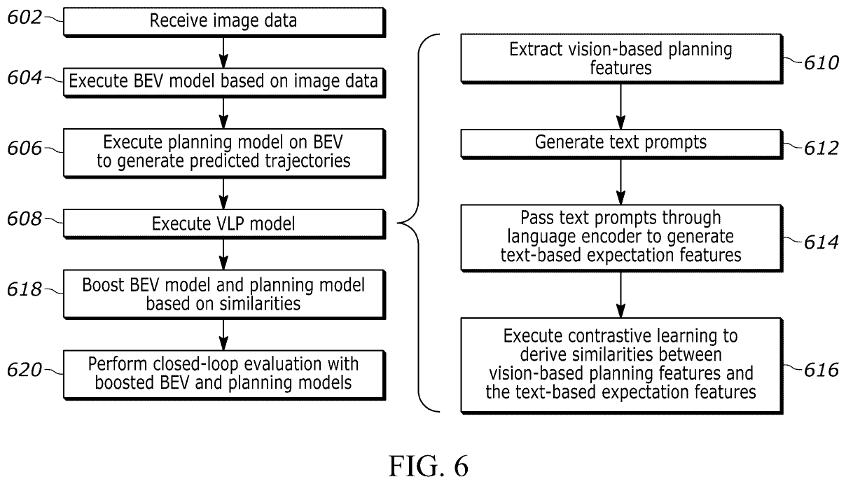

FIG. 6 illustrates a method 600 of training an end-to-end autonomous driving system (e.g., system 400) utilizing a VLP machine learning model in a closed-loop environment, according to an embodiment. The method can be carried out by one or more of the processors disclosed herein. At 602, image data is generated by a plurality of image sensors (e.g., camera, lidar, radar, etc.) mounted to or about a vehicle. The image sensors capture images of the environment about the vehicle. image processing is executed on the image data in order to detect agents in the environment. At 604, a BEV model is executed based on the images or image data. Object recognition and classification can be used, as explained above. A BEV (e.g., BEV 406) is generated based on the image data and the results of the object recognition or other object detection. The BEV includes spatiotemporal information associated with the vehicle and the detected agents in the environment. At 606, a planning model (e.g., planning model 412) is executed on the BEV to generate predicted trajectories of the autonomous vehicle to navigate the autonomous vehicle in the environment. The predicted trajectories can be used for issuing commands to be taken by the actuator 304 to navigate the autonomous vehicle, for example.

With this backdrop, improvements to the end-to-end autonomous driving system can be made. At 608, a VLP machine-learning model is executed to improve the end-to-end autonomous driving system. Execution of the VLP model at 608 can include the steps taken at 610-616, which are described as follows. At 610, vision-based planning features associated with the detected agents in the environment are extracted. The vision-based planning features can include the spatiotemporal information associated with detected agents in the images. This can be extracted from the simulation data, for example, as described above. Then, at 612, text prompts are generated based on the extracted spatiotemporal information. The text prompts are generated from ground truth labels, such as positions, heading, next positions, etc. in the current time frame using the ego vehicle coordinate system. At 614, the text prompts are passed through a language encoder to generate text-based expectation features associated with the detected agents. Finally, at 616, a contrastive learning model can be executed to derive similarities between the vision-based planning features and the text-based expectation features. A model such as CLIP may be used to perform this contrastive learning.

With these similarities produced by the contrastive learning model, at 618 the BEV model and the planning model can be boosted or improved. The contrastive learning allows for a modified BEV data and planning model output to be generated. These modified outputs are evaluated via closed-loop evaluations at 620. Here, a closed-loop evaluation of the end-to-end autonomous driving system is performed, wherein the system includes the boosted BEV model and the boosted planning model based on the similarities from the contrastive learning. The closed-loop evaluation is performed by interacting with a simulated environment in real-time and responding dynamically to actions taken by the vehicle based on the predicted trajectories. Evaluation metrics such as success rate and driving score can be captured during this closed-loop evaluation. The end-to-end autonomous driving system can then be modified based on the captured evaluation metrics.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training an end-to-end autonomous driving system utilizing a vision-language planning (VLP) machine learning model in a closed-loop environment, the method comprising:
receiving images generated from a plurality of image sensors mounted to a vehicle;
executing a BEV machine-learning model based on the images to generate a bird eye view (BEV) of the environment;
executing a planning machine-learning model on the BEV to generate predicted trajectories to navigate the autonomous vehicle in the environment;
executing a VLP machine-learning model to improve the end-to-end autonomous driving system, including:
extracting vision-based planning features associated with detected agents within the environment, wherein the vision-based planning features include spatiotemporal information associated with detected agents in the images;
generating text prompts based on the extracted spatiotemporal information associated with detected agents in the images;
passing the text prompts through a language encoder to generate text-based expectation features associated with the detected agents; and
executing a contrastive learning model to derive similarities between the vision-based planning features and the text-based expectation features;
boosting the BEV model and the planning model based on the similarities;
performing closed-loop evaluation of the end-to-end autonomous driving system with the boosted BEV model and the boosted planning model by interacting with a simulated environment in real-time and responding dynamically to actions taken by the vehicle based on the predicted trajectories;
capturing evaluation metrics during the closed-loop evaluation; and
modifying the end-to-end autonomous driving system based on the captured evaluation metrics.

2. The method of claim 1, wherein the images are generated from an open-source tool that simulates real-world driving environments.

3. The method of claim 2, wherein the generating of text prompts includes extracting text-based descriptions of ground truth data from the open-source tool.

4. The method of claim 3, wherein the open-source tool is CARLA.

5. The method of claim 1, wherein the closed-loop evaluation is performed via a Bench2Drive benchmark.

6. The method of claim 1, wherein the closed-loop evaluation includes determining a loss between the predicted trajectory of the vehicle and a ground truth trajectory of the vehicle.

7. The method of claim 1, wherein the text prompts are generated from ground truth labels associated with the images.

8. The method of claim 7, wherein the contrastive learning model includes:
a text encoder configured to output a text-based vector based on the text prompts; and
an image encoder configured to output an image-based vector representing image-based features associated with the detected agents in the BEV.

9. An end-to-end autonomous driving system utilizing a vision-language planning (VLP) machine learning model in a closed-loop environment, the system comprising:
a processor; and
memory including instructions that, when executed by the processor, cause the processor to:
receive image of an environment about a vehicle;
execute a BEV machine-learning model based on the images to generate a bird eye view (BEV) of the environment;
execute a planning machine-learning model on the BEV to generate predicted trajectories to navigate an autonomous vehicle in the environment;
execute a VLP machine-learning model to improve the end-to-end autonomous driving system by:
extracting vision-based planning features associated with detected agents within the environment, wherein the vision-based planning features include spatiotemporal information associated with detected agents in the images;
generating text prompts based on the extracted spatiotemporal information associated with detected agents in the images;
passing the text prompts through a language encoder to generate text-based expectation features associated with the detected agents; and
executing a contrastive learning model to derive similarities between the vision-based planning features and the text-based expectation features;
boost the BEV model and the planning model based on the similarities; and
perform closed-loop evaluation of the end-to-end autonomous driving system with the boosted BEV model and the boosted planning model by interacting with a simulated environment in real-time and responding dynamically to actions taken by the vehicle based on the predicted trajectories.

10. The system of claim 9, wherein the memory includes further instructions that, when executed by the processor, cause the processor to:
capture evaluation metrics during the closed-loop evaluation; and
modify the end-to-end autonomous driving system based on the captured evaluation metrics.

11. The system of claim 9, wherein the images are generated from an open-source tool that simulates real-world driving environments.

12. The system of claim 11, wherein the generating of text prompts includes extracting text-based descriptions of ground truth data from the open-source tool.

13. The system of claim 12, wherein the open-source tool is CARLA.

14. The system of claim 9, wherein the closed-loop evaluation is performed via a Bench2Drive benchmark.

15. The system of claim 9, wherein the closed-loop evaluation includes determining a loss between the predicted trajectory of the vehicle and a ground truth trajectory of the vehicle.

16. The system of claim 9, wherein the text prompts are generated from ground truth labels associated with the images.

17. The system of claim 7, wherein the contrastive learning model includes:
a text encoder configured to output a text-based vector based on the text prompts; and
an image encoder configured to output an image-based vector representing image-based features associated with the detected agents in the BEV.

18. A method comprising:
receiving images associated with an environment about a vehicle;
executing a BEV model on the images to generate a bird eye view (BEV) of the environment;
executing a planning model on the BEV to generate predicted trajectories to navigate an autonomous vehicle in the environment;
executing a VLP model to improve the end-to-end autonomous driving system by:
extracting vision-based planning features associated with agents within the environment, wherein the vision-based planning features include spatiotemporal information associated with agents;
generating text prompts based on the extracted spatiotemporal information;
passing the text prompts through a language encoder to generate text-based expectation features; and
executing a contrastive learning model to derive similarities between the vision-based planning features and the text-based expectation features;
boosting the BEV model and the planning model based on the similarities; and
performing closed-loop evaluation of the end-to-end autonomous driving system with the boosted BEV model and the boosted planning model by interacting with a simulated environment in real-time and responding dynamically to actions taken by the vehicle based on the predicted trajectories.

19. The method of claim 18, further comprising:
capturing evaluation metrics during the closed-loop evaluation; and
modifying the end-to-end autonomous driving system based on the captured evaluation metrics.

20. The method of claim 18, wherein the images are generated from CARLA that simulates real-world driving environments, and wherein the generating of text prompts includes extracting text-based descriptions of ground truth data from CARLA.
